(19) United States
(12) Patent Application Publication
(10) Pub. No.: US 2022/0292564 A1
(43) Pub. Date: Sep. 15, 2022

(54) METHOD FOR PROVIDING ITEM INFORMATION AND AN APPARATUS FOR THE SAME

(71) Applicant: Coupang Corp., Seoul (KR)

(72) Inventors: Su Jung Kim, Seoul (KR); Nae Jin Hyeon, Seoul (KR); Yeon Joo Ro, Seoul (KR)

(21) Appl. No.: 17/225,806

(22) Filed: Apr. 8, 2021

(30) Foreign Application Priority Data
Mar. 10, 2021 (KR) 10-2021-0031595

(51) Int. Cl. G06Q 30/06

(52) U.S. Cl. CPC G06Q 30/0625

(57) ABSTRACT

Provided is a method for providing item information of an electronic apparatus including at least one of identifying an item according to a first input of a user; identifying first review information created by selecting one from an answer set to a specific attribute of the item by purchasers and second review information on an answer determined based on a frequency of selection of the purchasers from the first review information; and providing a terminal of the user with a first page including information on or regarding the item, the first review information displayed in a first area, and the second review information displayed in a second area distinguished from the first area.

### BACKGROUND

### Technical Field

Example embodiments of the present disclosure relate to a method and/or an apparatus for providing information on or regarding a plurality of items.

### Description of the Related Art

The result of a keyword search for purchasing a product provides information on the searched product. Various platforms that sell products provide information on products that consumers want to purchase and comparable products.

If information is provided so that consumers can compare products with similar specifications to products they want to purchase, consumers can broaden their product selection and sellers can increase sales opportunities for the products they are selling.

Korean Patent Registration No. 1859055 is a prior document for providing such comparative information on products.

As such, there is a need for a method of effectively providing information for purchasing products.

### SUMMARY

### Technical Goals

If purchasers' comments on the item to be purchased are provided only, it is difficult to grasp objective and accurate information on a clear standard from the perspective of a consumer who purchases the item (product, etc.), which may lead to unreasonable consumption.

Sellers who want to sell an item face a real problem that makes it difficult to completely provide consumers with the most necessary information about the item. However, if purchasers' comments on the item to be purchased are provided only, it is difficult to provide objective information on the item to consumers even from the perspective of a seller who wants to sell the item. It is difficult to establish an efficient sales strategy, and it is difficult to extract accurate statistical information about sales and purchases of products.

Thus, an aspect of the present disclosure is to provide consumers and sellers who want to purchase and sell with the product information on the product to be purchased and sold and objective information on the item created by the consumers in an organized or conspicuous manner.

### Technical Solutions

According to an aspect, there is provided a method for providing item information of an electronic apparatus, the method including at least one of: identifying an item according to a first input of a user; identifying first review information created by selecting one from an answer set to a specific attribute of the item by purchasers; identifying second review information on an answer determined based on a frequency of selection of the purchasers from the first review information; and providing a terminal of the user with a first page including information on the item, the first review information displayed in a first area, and the second review information displayed in a second area distinguished from the first area.

The method of providing item information according to some example embodiments may further include identifying a characteristic of the user, and the second review information may be identified according to the frequency of selection of first purchasers corresponding to the characteristic of the user among the purchasers.

Moreover, the second area according to some example embodiments may be located in a portion that can be exposed without scrolling when the first page is displayed on the user terminal.

Moreover, the method may further include providing a second page including the first review information in response to a second input related to the second review information according to some example embodiments.

Furthermore, the specific attribute according to some example embodiments may be selected based on a characteristic of the item.

In addition, the first page may further include information indicating the specific attribute.

In addition, the information on the item according to some example embodiments may include an image of the item, and the specific attribute may be one of a size of the item and a color of the item.

Moreover, the method of providing item information according to some example embodiments may further include identifying a size for the user based on the characteristic of the first purchasers, the size of the item purchased by the first purchasers, and the answer selected by the first purchasers.

According to some example embodiments, when the specific attribute is the size of the item, the answer set may include a first answer indicating that the size of the item is smaller than the size shown in the image of the item, a second answer indicating that the size of the item is similar to the size shown in the image of the item, and a third answer indicating that the size of the item is larger than the size shown in the image of the item, and, when the specific attribute is the color of the item, the answer set may include a fourth answer indicating that the color of the item is similar to the color shown in the image of the item, a fifth answer indicating that the color of the item is the same as the color shown in the image of the item, and a sixth answer indicating that the color of the item is different from the color shown in the image of the item.

In addition, the second review information according to some example embodiments may include the most frequently present answer among the first review information and a frequency rate of the most frequently present answer.

Moreover, the first page may further include a first indicator when the number of the most frequently present answer in the first review information is greater than a half of the number of answers in the first review information. In addition, the second review information may be represented on the first page to be always displayed on the terminal of the user even if the user scrolls beyond a specific range.

### Effects

According to some example embodiments, it is possible to provide users with a clear evaluation criterion to objectively evaluate an item according to the clear evaluation criterion.

The method of providing item information according to some example embodiments may provide objective and clear information about an actual product to purchasers who want to purchase an item.

The method of providing item information according to some example embodiments may generate statistically meaningful and machine-learnable data for item information due to some configurations, contributing to extracting new information about an item.

Due to some configurations, the method of providing item information according to some example embodiments can display objective evaluation information according to a clear evaluation criterion in a prominent position. Due to some display method, necessary information about the item can be easily provided to users who want to purchase the item.

The method of providing item information according to some example embodiments can provide accurate and objective review information about the item to users who want to purchase the item due to some configurations, and induce users to purchase by providing important information for the user's purchase decision.

In addition, in the method of providing item information according to example embodiments, by providing an appropriate indicator on a product detail page based on a specific condition, it is possible to conspicuously provide users with highly reliable information about the product.

### BRIEF DESCRIPTION OF THE DRAWINGS

FIG. 1 illustrates examples of internal components of an electronic apparatus according to example embodiments.

FIG. 2 is an exemplary diagram illustrating a method of providing information on or regarding an item and information on a detailed review of an item according to example embodiments.

FIG. 3 is an exemplary diagram of a method of providing information on an item according to example embodiments.

FIG. 4 illustrates exemplary diagrams of a method of providing information on detailed review of an item according to example embodiments.

FIG. 5 illustrates exemplary diagrams of a method of providing representative review information of an item according to example embodiments.

FIG. 6 is an exemplary diagram illustrating a method of providing detailed information on a review of an item according to example embodiments.

FIG. 7 illustrates exemplary diagrams of an example of a method for providing item information according to example embodiments.

### DETAILED DESCRIPTION

Some example embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

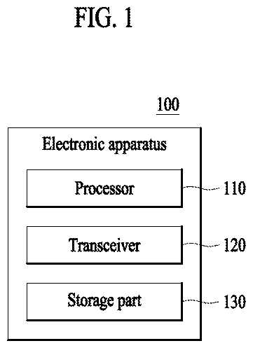

FIG. 1 illustrates examples of internal components of an electronic apparatus according to example embodiments.

Referring to FIG. 1, the internal components of the electronic apparatus 100 are not limited to the illustrated components. The electronic apparatus 100 may include at least one of a processor 110, a transceiver 120, and a storage part 130.

The processor 110 may process a series of operations for performing a method for providing item information according to various some example embodiments of the present disclosure. The processor 110 may control other components of the electronic apparatus 100. Meanwhile, in some example embodiments, a product may be used as a term referring to a specific item, and an item may be sold to a user in a service related to the electronic apparatus 100.

The processor 110 may identify detailed information on or regarding a first product in response to a request on a first page for the first product. When the processor 110 identifies through the storage part 130 that the first product is included in a specific category, the processor 110 may identify at least one second product corresponding to the specific category. The processor 110 may identify at least one attribute list corresponding to the specific category, and the attribute list may be previously stored in the storage part 130 or may be received from the outside through the transceiver 120. The processor 110 may provide the first page on a display of the electronic apparatus 100. The first page may include a first part in which detailed information on the first product is provided, a second part where first attribute information of the first product corresponding to the attribute list is provided, and a third part where second attribute information of at least one second product corresponding to the attribute list is provided.

The transceiver 120 may perform functions of transmitting information stored in the storage part 130 of the electronic apparatus 100 or information processed by the processor 110 to another apparatus or receiving information from another apparatus to the electronic apparatus 100.

The storage part 130 is a data structure implemented in a predetermined storage space of the electronic apparatus 100, and functions such as storing, searching, deleting, editing, or adding data may be freely performed. For example, the storage part 130 may include fields or elements for processing functions such as storing, searching, deleting, editing, or adding data. The storage part 130 may store data related to the electronic apparatus 100 performing a method of managing data. For example, the storage part 130 may store instructions or data for an execution operation of the processor 100. The storage part according to some example embodiments may include, for example, a database.

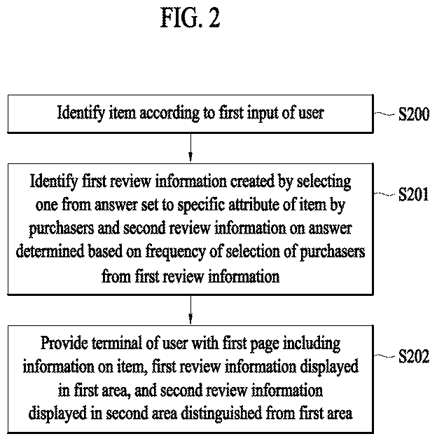

The electronic apparatus according to some example embodiments may perform a method for providing item information according to some example embodiments. The method of providing item information according to some example embodiments has been described with illustrations in FIGS. 2 to 6.

Operations according to some example embodiments described below may be performed by a combination of at least one of the processor 110, the transceiver 120, and the storage part 130 according to some example embodiments shown in FIG. 1. The method of providing item information according to some example embodiments described below may be performed by a combination of at least one of the processor 110, the transceiver 120, and the storage part 130 according to some example embodiments. Information (or data) according to some example embodiments described below may be stored, for example, in the storage part 130.

FIG. 2 is a flowchart showing an exemplary method of providing item information according to some example embodiments.

The method of providing item information according to some example embodiments may be performed, for example, in the electronic apparatus 100 of FIG. 1. The electronic apparatus on which the method of providing item information is performed may be referred to as, for example, an item information providing apparatus, and may be implemented in the form of a server.

The method of providing item information according to some example embodiments may include at least one of operation S200 of identifying an item according to a first input of a user, operation S201 of identifying first review information created by selecting one from answer set to a specific attribute of the item by other purchasers for the identified item, and identifying second review information on an identified answer according to a selection frequency of purchasers among the answer set of the first review information, and operation S202 of providing a first page including information on or regarding the item, the first review information displayed in a first area, and the second review information displayed in a second area distinguished from the first area to a terminal of the user. Meanwhile, in some example embodiment, the electronic apparatus 100 may identify the user's characteristic information in advance, and may identify the second review information based on a frequency selected by purchasers corresponding to the user's characteristic information among the review information. In this way, as the second review information is identified in consideration of the user's characteristics, more useful review information can be identified for the user, and purchase incentives may increase according to the review information. In some example embodiments, the user's characteristic information may include at least one of the user's age, the user's purchase history, the user's body size, the user's gender, and the user's preferred brand information.

In operation S200, an item is identified according to a first input of a user.

The first input of the user includes information for the user to select an item, and, for example, may be an input that the user provides to the user's terminal device in order to identify information on the item. The electronic apparatus 100 may obtain information corresponding to the first input and provide a page including information on the item accordingly. The information on the item may include, for example, an image representing the item, name of the item, review information on the item, detailed information on the item, and so on.

The item may include an article, a service, and the like shown by the apparatus for providing item information according to some example embodiments. The item may be, for example, an article such as clothing, electronic product, or food, or may be a service related to the article or a separately provided service.

In the method of providing item information according to some example embodiments, a first signal inputted by the user to identify an item may be received and identified in operation S200.

In operation S201, the first review information created by selecting one from an answer set to a specific attribute of the item by other purchasers is identified.

Purchasers who have purchased an item can perform an evaluation on the attribute(s) of the item.

For example, purchasers who have purchased an item can evaluate if the size of the item is larger, smaller, or similar to the size shown in an image provided on an item detail page or the like. Purchasers who have purchased an item may create review information including a comment in the form of a text string for such evaluation and transmit it to the apparatus for providing item information according to some example embodiments.

However, if users write only comments in the form of text strings directly written by the users, it may be difficult to quantify users' evaluations or extract statistically meaningful information. In addition, when purchasers write comments in the form of text strings only, it may be difficult to extract the evaluation of an item in a form that can be mechanically analyzed.

Accordingly, the method of providing item information according to some example embodiments provides a specific attribute and an exemplary answer set for the specific attribute to purchasers who have purchased the item to select at least one of the answers included in the answer set to each attribute. For example, the method of providing item information according to some example embodiments may allow the purchaser who has purchased the item to select at least one answer from the answers included in the answer set as to whether the size of the item is appropriate, whether the color of the item is similar to the color shown in the image, the shape of the item is similar to the shape shown in the image, or the like.

Due to this configuration, the method of providing item information according to some example embodiments may present a clear evaluation criterion to users, allowing objectively evaluating an item according to the clear evaluation criterion.

In addition, due to such a configuration, the method of providing item information according to some example embodiments can provide objective and clear information about an actual product to purchasers who want to purchase an item.

Furthermore, the method of providing item information according to some example embodiments may generate statistically meaningful and machine-learnable data for item information due to this configuration, contributing to extracting new information about an item.

Specific attributes may include characteristics of an item, and the like. The characteristics of the item may include, for example, the size of the item, the color of the item, the shape or look of the item, and so on.

The answer set may include a group of answers including evaluations of purchasers corresponding to the attribute of the item. The answers included in the answer set may be a predefined answer set in the method of providing item information according to example embodiments, or may be newly established by purchasers.

For example, the answer set to the size of an item may include an answer indicating that the size of the item purchased and received by the actual purchaser is smaller than the image of the item provided on the item detail page (first page), etc., an answer indicating that the size of the item purchased and received by the actual purchaser is similar to the image of the item provided on the item detail page (first page), etc., and an answer indicating that the size of the item purchased and received by the actual purchaser is larger than the image of the item provided on the item detail page (first page), etc.

For example, the answer set to the color of an item may include an answer indicating that the color of the item purchased and received by the actual purchaser is different from the image of the item provided on the item detail page (first page), etc., an answer indicating that the color of the item purchased and received by the actual purchaser is similar to the color shown in the image of the item provided on the item detail page (first page), etc., and an answer indicating that the color of the item purchased and received by the actual purchaser is the same as the color shown in the image of the item provided on the item detail page (first page), etc.

The first review information may include information created by other purchasers by selecting one from the answer set to a specific attribute. The first review information may include information including at least one answer selected by each purchaser for various attributes. For example, the first review information may include information representing the number of purchasers who have selected an answer from the answer set, information about each purchaser, information representing one or more attributes answered by each purchaser, and at least one answer selected to each attribute answered by each purchaser.

The first review information may be variously referred to as, for example, answer information.

Review information may include at least one of the first review information according to some example embodiments and a comment written on an item by each user.

In operation S201, the second review information on the identified answer according to the frequency of selection of purchasers among the answer set of the first review information is identified.

The second review information includes an answer determined according to the frequency of selection of answers selected by other purchasers from the first review information. Specifically, the second review information may be determined as the answer that appears most frequently among purchasers' answers to each attribute included in the first review information. That is, the second review information may be a data structure in which a specific attribute and the most frequent answer to the specific attribute are mapped and stored.

For example, in the first review information, the answer indicating that the size of the item purchased and received by the actual purchaser is smaller than the image of the item provided on the item detail page (first page) may appear most frequently among all purchasers' answers to the size attribute. In this case, the second review information may be a data structure in which the size attribute and the above-described answer are mapped and stored.

According to another example embodiment, the second review information may be determined as the answer that appears in the most majority among purchasers' answers to each attribute included in the first review information. For example, the second review information may be the answer that is most frequently present in the first review information, and the number of answers that are most frequently present may be greater than a half of the total number of answers in the first review information.

In operation S202, a first page including information on the item, the first review information displayed in the first area, and the second review information displayed in the second area distinguished from the first area is provided on the user's terminal.

The method of providing item information according to some example embodiments may provide the user's terminal device with the first page including information on the corresponding item by performing operations shown in S201 to S202 described above in response to the first input. The first page may be variously referred to as a product detail page (PDP), an item detail page, or the like. The first page is a page that provides detailed information about an item to the user, including an image representing the item, item name, item review information, and detailed information about the item.

The first page according to some example embodiments may further include review information. The review information may be located at the bottom of the first page, for example.

The first page according to some example embodiments may further include the second review information. The second review information according to some example embodiments may be displayed at a location that can be exposed without scrolling in the user terminal. The second review information according to some example embodiments may be displayed in a specific area (or location) on the first page according to example embodiments, and may be located in front of other components included in the first page. Meanwhile, in some example embodiments, the electronic apparatus may obtain information on the user terminal and change the area where the second review information is displayed according to the characteristics of the user terminal.

For example, the information for providing and indicating the first page may include information describing a style of a partition or container included in the first page. In the information describing the style, the position attribute of the area containing the second review information (e.g., a component, container, or div in HTML) may have a value of ‘fixed’ or ‘absolute.’ Therefore, due to this configuration, the second review information according to the some example embodiments can be displayed at a location that can be exposed without scrolling on the user terminal, and even if the user scrolls, the second review information can be fixed at a specific location on the display screen of the terminal device viewed by the user.

For example, the second review information may be configured to be represented on the first page so that it is always displayed on the user's terminal even if the user scrolls beyond a specific range.

Due to this configuration, the method of providing item information according to some example embodiments can display objective evaluation information according to a clear evaluation criterion in a prominent position. Due to this display method, necessary information about the item can be easily provided to users who want to purchase the item.

As described above, the method of providing item information according to some example embodiments may further include operation of identifying the characteristics of the user. In the method of providing item information according to example embodiments, the second review information may be identified based on the frequency selected by purchasers corresponding to the user's characteristic information among the review information according to the example embodiments.

The method of providing item information according to some example embodiments may further include operation of identifying a size of an item for the user based on the characteristics of purchasers who purchased the item, the size of the item purchased by the purchasers, answers selected by the corresponding purchasers, and characteristics of the user (e.g., body size, etc.). For example, in the method of providing item information according to example embodiments, a characteristic (e.g., clothing size) suitable for the user is identified using purchase information of purchasers, or the like.

For example, when a user purchases a top item, the user's usual top size can be identified first. The usual top size may be information set by the user. In the method of providing item information according to example embodiments, purchasers whose usual top size (body size) set to the same size as the user can be identified, and the size of the item actually purchased by the identified purchasers can be checked. In addition, the method of providing item information according to some example embodiments may further confirm the size of the item suitable for the user as a result of the check, and provide the confirmed size of the item to the user.

For example, when the user's body size is 105, the method of providing item information according to some example embodiments identifies purchasers whose body size is 105. Although the sizes that the identified purchasers actually purchased are all 105, the answer to the size of the majority of purchasers may be the answer meaning that “Bigger than expected.” In this case, in the method of providing item information according to example embodiments, an item (clothing) of a size smaller than 105 may be proposed to the user. Conversely, the sizes that the identified purchasers actually purchased are all 105, but the answer to the size of the majority of purchasers may be the answer meaning that “Smaller than expected.” In this case, in the method of providing item information according to example embodiments, an item (clothing) of a size larger than 105 may be proposed to the user.

In another embodiment, the method of providing item information may calculate a bias to the item based on the characteristics of purchasers who purchased the item (purchasers matching the characteristics of the user), the characteristics of the item that the purchasers actually purchased, and the purchasers' answers. For example, if the body size of a specific purchaser is 95, but the size of the item purchased by the purchaser is 90, and the purchaser's answer is “Bigger than expected,” the item should have a large bias to the characteristics of the size. Conversely, if the body size of a specific purchaser is 95, but the size of the item purchased by the corresponding purchaser is 95, and the answer of the purchaser is “True to size,” the item should have a small bias to the characteristics of the size. The method of providing item information may recommend the attributes of the item appropriate for the user by calculating the bias to the item using the characteristics of all purchasers (or purchasers who match the user's characteristics), the characteristics of the item that the purchasers actually purchased, and the answers of the purchasers and applying the bias to the characteristic of the user.

Accordingly, the first page according to some example embodiments may further include information on the attribute of an item suitable for the user (e.g., information on the size of the item suitable for the user) with respect to the specific attribute.

The method of providing item information helps a user to make an accurate judgment in selecting an attribute of an item due to such an operation or configuration, and induces the user to purchase the correct item.

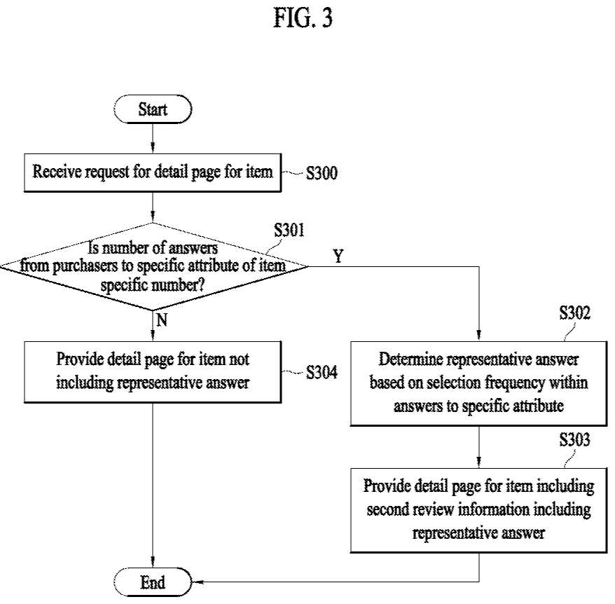

FIG. 3 is a flowchart of a method for providing item information according to example embodiments.

The method of providing item information according to some example embodiments shown in FIG. 3 may be performed by the electronic apparatus 100 of FIG. 1. The electronic apparatus on which the method of providing item information is performed may be referred to as, for example, an item information providing apparatus.

The method of providing item information according to some example embodiments may include operation S300 of receiving a request for a detail page for an item and operation S301 of checking whether the number of answers from purchasers to a specific attribute of the item is three or more. Meanwhile, the number of answers from purchasers may be checked based on the number of users who gave answers to a plurality of attributes.

In operation S300, a request for a detail page for an item is received in the method for providing item information according to example embodiments. In operation S300, operation S200 of FIG. 2 may be performed, for example. The detail page for the item may be, for example, the first page of FIG. 2. The request for the detail page for the item may include the first input of the user of FIG. 2.

In operation S301, the number of answers from purchasers to a specific attribute of the item is checked whether it is greater than or equal to a specific number in the method of providing item information according to example embodiments. Here, the specific number may be, for example, 3 or more.

Answers from purchasers for a specific attribute may be included in the first review information of FIG. 2.

For example, in the method of providing item information according to example embodiments, the number of purchasers of the item is 10, the number of answers to the size attribute is 5, and the number of answers to the color attribute is 2, in the first review information according to FIG. 2, the answers for the size attribute in which the number of answers is 5 is checked.

If the number of answers from purchasers to a specific attribute of an item is a specific number (for example, 3) or more, the method of providing item information according to some example embodiments may include operation S302 of determining a representative answer based on the selection frequency within the answers to the specific attribute and operation S303 of providing at least one of a detail page for the item including the second review information including the representative answer.

In operation S302, the representative answer is determined based on the selection frequency within answers to a specific attribute. In operation S302, operation S202 of FIG. 2 may be performed. The representative answer may include, for example, ‘an answer determined according to the frequency of selection of other purchasers’ described in S202 of FIG. 2.

The representative answer may include, for example, an answer that most frequently exists among the first review information according to example embodiments. The representative answer may include the answer shown in the second review information described in FIG. 3.

The representative answer may be determined as the answer that appears in the most majority among purchasers' answers for each attribute included in the first review information. For example, the second review information is the answer that is most frequently present in the first review information, and the number of answers that are most frequently present may be greater than a half of the total number of answers in the first review information.

The second review information according to some example embodiments may include the frequency rate of the most frequently existing answers described above. That is, the second review information according to the some example embodiments includes the attribute of the item, the answer that most frequently exists among the answers of the item for the corresponding attribute, and the frequency rate occupied by the answer that exists most frequently within the answers of the item to the corresponding attribute. The frequency rate can be expressed as a percentage, for example.

In operation S303, a detail page for the item including the second review information including the representative answer to each attribute according to some example embodiments is provided. The detail page may include, for example, the first page of FIG. 2.

When the number of answers from purchasers to a specific attribute of the item is less than a specific number (e.g., 3), the method of providing item information according to some example embodiments may provide a detail page for the item that does not include a representative answer in operation S304.

In the method of providing item information according to example embodiments, due to such a configuration, a clear evaluation criterion may be presented to users, and an item may be objectively evaluated according to the clear evaluation criterion. In addition, due to such a configuration, the method of providing item information according to some example embodiments can provide objective and clear information about an actual product to purchasers who want to purchase the item.

The method of providing item information according to some example embodiments may generate statistically meaningful and machine-learnable data for item information due to this configuration, thereby contributing to extracting new information about the item. Further, due to this configuration, the method of providing item information according to some example embodiments can display objective evaluation information according to a clear evaluation criterion in a prominent position. Due to this display method, necessary information about the item can be easily provided to users who want to purchase the item.

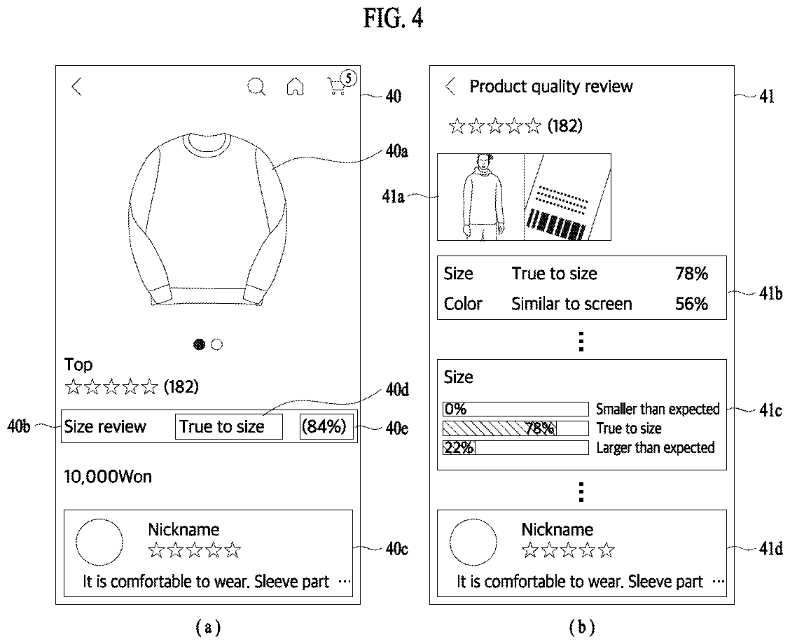

FIG. 4 illustrates exemplary diagrams of an item detail page and an item detailed review page according to example embodiments.

FIG. 4A illustrates an example of an item detail page in which a method for providing item information according to some example embodiments displays information on or regarding an item according to example embodiments. The item detail page shown in FIG. 4A may include, for example, the first page of FIGS. 1 to 3, a product detail page, or the like.

Referring to FIG. 4A, the item detail page 40 may be a page provided to a user in response to receiving a request for a detail page for an item from the user's terminal device. The item detail page 40 may include a first area 40a displaying image or video data representing an item, a second area displaying the name of the item (for example, ‘Gray top’ in FIG. 4A), and a third area indicating the total rating of the item, a fourth area indicating the selling price of the item, a fifth area 40b indicating representative review information of the item, and a sixth area 40c indicating detailed review information of the item.

The first area 40a displaying image or video data representing the item may include an image or video related to the item.

The fifth area 40b indicating the representative review information of the item may include an attribute of the item, a representative answer 40d according to some example embodiments of the corresponding attribute, and information indicating a frequency rate 40e of the representative answer within all answers of other purchasers to the corresponding attribute.

The fifth area 40b indicating the representative review information of the item may include the second review information shown in FIGS. 2 to 3.

The fifth area 40b indicating the representative review information of the item may be displayed at a location that can be exposed without scrolling in the user terminal. The second review information according to some example embodiments may be displayed in a specific area (or location) on the first page according to example embodiments, and may be located in front of other components included in the first page. Meanwhile, in some example embodiments, the position at which the second review information is displayed may be fixed within the first page. In addition, in some example embodiments, the front position may include that a user can check the corresponding information with less manipulation, and, for example, it may include being displayed at a position to be checked without scrolling.

For example, the information for providing the first page may include information describing a style of the fifth area 40b indicating the representative review information of the item included in the first page. In the information describing the style, the position attribute of the area containing the second review information (e.g., a component, container, or div in HTML) may have a value of ‘fixed’ or ‘absolute.’ Therefore, due to this configuration, the fifth area 40b indicating the representative review information of the item according to the some example embodiments can be displayed at a location that can be exposed without scrolling on the user terminal, and even if the user scrolls, the second review information can be fixed at a specific location on the display screen of the terminal device viewed by the user.

The sixth area 40c indicating the detailed review information of the item includes the detailed review information of the item. The detailed review information of the item may include at least one of the first review information according to example embodiments, a comment written on the item by each user, and answers in answer set selected by each user for the item.

The attributes of the item may include characteristics of the item, and the like. The characteristics of the item may include, for example, the size of the item, the color of the item, the shape or look of the item, and so on. The attributes of the item may include the attributes of FIGS. 2 and 3.

The representative answer 40d according to some example embodiments to the corresponding attribute may include an answer determined according to the frequency among purchasers' answers to the attribute for the item. For example, the representative answer may include an answer that appears most frequently among purchasers' answers to the corresponding attribute.

The frequency rate 40e may include a share of the representative answer 40d according to the some example embodiments in purchasers' answers to the corresponding attribute.

FIG. 4B shows a detailed review page 41 to present a detailed review of an item to a user in a method of providing item information.

The detailed review page 41 for the item according to some example embodiments may be, for example, a page that is moved in response to a click of the fifth area 40b indicating the representative review information of the item in FIG. 4A.

Referring to FIG. 4B, the detailed review page 41 for the item according to some example embodiments may include at least one of a seventh area 41a representing an image or video of the item provided by purchasers, an eighth area 41b representing answer statistics summary information, a ninth area 41c representing answer statistics information, and a tenth area 41d representing detailed review information of the item.

The eighth area 41b representing the answer statistics summary information may include at least one of an attribute, a representative answer to the attribute, and a share of the representative answer in all answers. For example, in the case where the answer ‘True to size’ accounts for 78% of the total answers among the answers to the size, the answer ‘True to size’ is determined as the representative answer in the method of providing item information according to example embodiments, and the attribute, the determined representative answer, and the share (78%) of the determined representative answer may be displayed in at least one of the eighth area 41b representing answer statistics summary information. For example, in the case where the answer ‘Similar to screen’ accounts for 56% of the total answers among the answers to the color, the answer ‘Similar to screen’ is determined as the representative answer in the method of providing item information according to example embodiments, and the attribute, the determined representative answer, and the share (56%) of the determined representative answer may further be displayed in at least one of the eighth area 41b representing answer statistics summary information.

The ninth area 41c representing the answer statistics information includes an area that visually represents the degree to which each answer to each attribute occupies within all answers to the corresponding attribute in the form of a chart or the like. For example, for the size attribute of an item, if there is no answer of ‘Smaller than expected’ among purchasers' answers, 78% of the answer is ‘True to size,’ and 22% of the answer is ‘Bigger than expected,’ the ninth area 41c representing the answer statistics information may include a chart in which the corresponding occupancy rate is displayed as a bar chart, a pie chart, a Gantt chart, or the like.

The tenth area 41d representing detailed review information of the item may include information on a purchaser who has purchased the item, comment information on or regarding the item created by the purchaser (for example, ‘It is comfortable to wear. Sleeve part . . . ’ part in FIG. 4B), or an answer to the attribute selected by the purchaser.

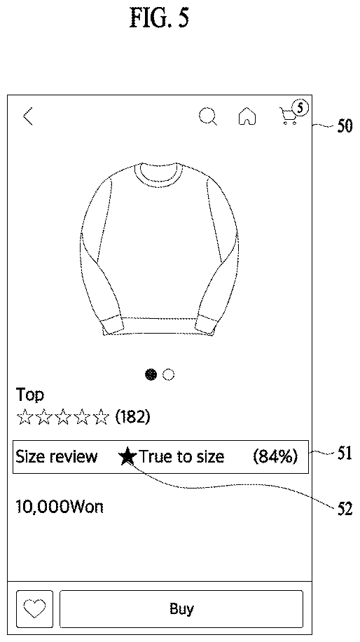

FIG. 5 shows an example of an item detail page according to example embodiments.

The item detail page according to some example embodiments shown in FIG. 5 may include the item detail page 50 or the first page 50 shown in FIGS. 2 to 4. The item detail page 50 according to some example embodiments may include areas as described with reference to FIG. 4.

The item detail page 50 according to some example embodiments may include a fifth area 51 indicating representative review information of an item. The fifth area 51 indicating the representative review information of the item may include at least one of an attribute for the item (for example, ‘size review’), a representative answer for the attribute (for example, ‘True to size’), and frequency rate (occupancy rate) of the corresponding representative answer (for example, 84%).

According to example embodiments, when the representative answer to a specific attribute accounts for a majority of the total answers to the specific attribute (that is, when the frequency rate exceeds 50%), the fifth area 51 indicating the representative review information of the item may further include an indicator 52. The indicator 52 may have various shapes (e.g., star shape, heart shape, other logo shape, etc.).

The method of providing item information according to some example embodiments may provide the item detail page 50 according to some example embodiments to the user's terminal device.

The method of providing item information according to some example embodiments provides purchasers of the item with an answer set to at least one attribute of an item. The purchasers may select one answer from the answer set to each attribute through the purchasers' terminal devices. In the method of providing item information according to example embodiments, the answer selected by the purchaser to each attribute is collected. In the method of providing item information according to example embodiments, an answer that appears most frequently among collected answers to each attribute is determined as a representative answer for the corresponding attribute.

At this time, when the number of answers of the representative answer to the corresponding attribute accounts for more than a half of the total number of answers to the corresponding attribute (i.e., the share of the representative answer is a majority), the method of providing item information according to some example embodiments may include the indicator 52 according to some example embodiments in the fifth area 51 indicating the representative review information of the item.

The method of providing item information according to some example embodiments can provide accurate and objective review information about the item to users who want to purchase the item due to this configuration, and induce users to purchase by providing important information for the user's purchase decision.

In addition, in the method of providing item information according to example embodiments, by providing the indicator 52 on a product detail page based on a specific condition, it is possible to conspicuously provide users with highly reliable information about the product.

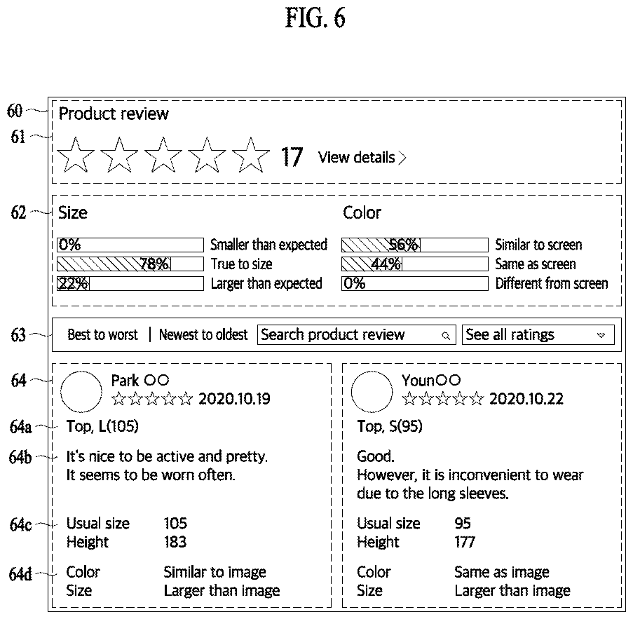

FIG. 6 illustrates an example of an item detailed review page according to example embodiments.

The item detailed review page 60 according to some example embodiments may indicate the item detailed review page 41 according to some example embodiments shown in FIG. 4B. The item detailed review page 60 according to some example embodiments may include, for example, a page provided to the user's terminal device in response to a click of the fifth area 40b indicating the representative review information of the item in FIG. 4A.

The item detailed review page 60 according to some example embodiments may include at least one of an evaluation area 61 for providing evaluation information for an item, a statistics area 62 for representing answer statistics information of purchasers to the item, a search area 63 for searching for detailed reviews of the item, and a detailed review area 64 including detailed review information of the item.

The evaluation area 61 represents the overall score for the item. The overall score for the item may include an average of scores received from purchasers who have purchased the item. The evaluation area 61 may further include information indicating the number of purchasers who have entered a score.

The statistics area 62 representing the answer statistics information may include an area visually representing the degree to which each answer to each attribute occupies within all answers to the corresponding attribute in the form of a chart or the like. The statistics area 62 representing the answer statistics information may include the ninth area 41c representing the answer statistics information of FIG. 4.

The search area 63 may include an area for performing a function of searching for a detailed review of a specific purchaser(s) from detailed review information included in the detailed review area 64 that follows.

The detailed review area 64 contains detailed reviews including comments made by one or more purchasers of the item. The detailed review area 64 may include at least one of information on a purchaser, a score on an item determined by the purchaser, and a writing date of a review written by the purchaser.

The detailed review area 64 may include information 64a related to an attribute of an item purchased by a purchaser. For example, the detailed review area 64 may further include information indicating the size of the item purchased by the purchaser (for example, the L(105) part with reference to FIG. 6) and the color of the item (for example, gray top with reference to FIG. 6).

The detailed review area 64 may include a comment 64b written by the corresponding purchaser.

The detailed review area 64 may further include body information 64c for the corresponding purchaser. The body information may include at least one of, for example, information on the size that the purchaser usually purchases for an item of the same type (for example, in the case of a top, information indicating the usual size of the top that the purchaser usually purchases) and information indicating the height of the purchaser.

The detailed review area 64 may include attributes of the item purchased by the corresponding purchaser and an answer selected by the purchaser for each attribute.

The method of providing item information according to some example embodiments may provide a user with at least one of a search function and a filtering function based on information (e.g., a character string, etc.) included in the detailed review area 64. For example, when the height of the user is 182 cm, the method of providing item information according to some example embodiments may provide the user's terminal device with detailed review information of other purchasers having a height similar to that of the user (for example, height within 5 cm difference) by filtering.

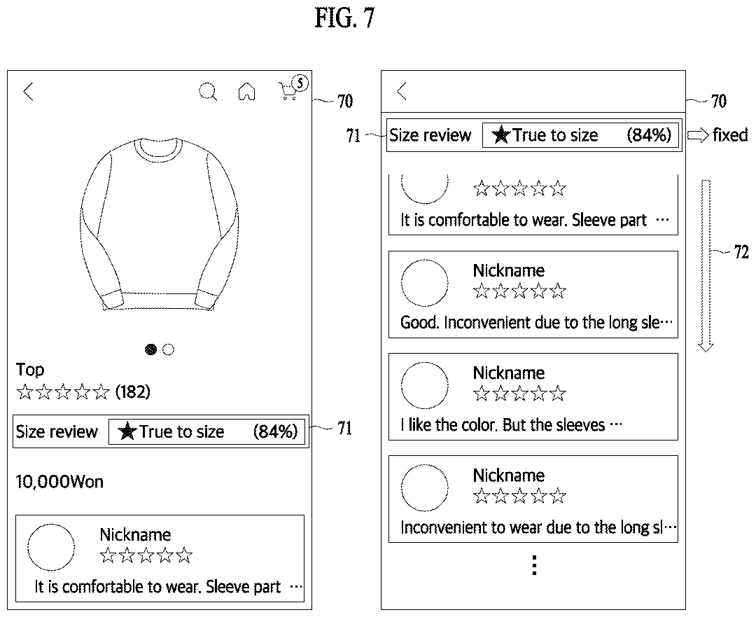

FIG. 7 shows some example embodiments in which representative answer information is fixed on an item detail page according to example embodiments.

The item detail page 70 according to some example embodiments shown in FIG. 7 may include the item detail page (or the first page, SDP, etc.) according to some example embodiments shown in FIGS. 2 to 6. The item detail page according to some example embodiments may include (the fifth area, 71) at least one of an attribute according to the some example embodiments described in FIGS. 2 to 6, a representative answer to the corresponding attribute, a share of the corresponding representative answer in the answers to the corresponding attribute, and an indicator according to example embodiments.

Here, the fifth area 71 including the attribute, the representative answer to the corresponding attribute, the share occupied by the corresponding representative answer in the answers to the corresponding attribute, and the indicator according to the some example embodiments can be displayed in a location that can be seen by the user without scrolling on the user's terminal.

According to example embodiments, the fifth area 71 may be fixed so that it can be viewed by the user even if there is a user's scroll in the user's terminal device. For example, the fifth area 71 may be configured to be represented on the first page to be always displayed on the user's terminal even if the user scrolls beyond a specific range.

For example, when the item detail page 70 according to some example embodiments is a page implemented in a web-based language, the fifth area 71 may be implemented to be positioned relatively in front of other components (e.g., z-index value is adjusted to a higher level), or the style representing the position can be set to a value of fixed or absolute.

Accordingly, due to this configuration, the corresponding area 71 may be configured to be displayed in a specific area of the user's terminal device even if the user scrolls down 72 to view the bottom of the page.

The method of providing item information according to some example embodiments can provide accurate and objective review information about the item to users who want to purchase the item due to this configuration, and induce users to purchase by providing important information for the user's purchase decision.

In addition, in the method of providing item information according to example embodiments, by providing such an indicator on a product detail page based on a specific condition, it is possible to conspicuously provide users with highly reliable information about the product.

Meanwhile, some example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the some example embodiments disclosed herein.

The electronic apparatus or terminal according to the above-described some example embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-Access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, some embodiments may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

The above-described some example embodiments are merely examples, and other embodiments may be implemented within the scope of the claims to be described later.

Meanwhile, some example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the some example embodiments disclosed herein.

1. A method operable by an electronic apparatus to provide a product attribute recommendation, the method comprising:
receiving, by a transceiver of the electronic apparatus, a first input from a user device;
identifying, by a processor of the electronic apparatus, an item based on the first input;
determining, by the processor, a first attribute of the item;
determining, by the processor, a physical attribute of the user, the physical attribute of the user associated with the first attribute of the item;
based on the physical attribute of the user, identifying, by the processor, a plurality of other purchasers of the item who share the physical attribute;
determining, by the processor, a plurality of purchase information for the item associated with the plurality of other purchasers for the item, wherein the plurality of purchase information comprises information associated with the first attribute of the item;
identifying, by the processor, a plurality of review information associated with the plurality of other purchasers for the item, wherein the plurality of review information comprises information associated with the first attribute of the item; and
generating, by the processor, a first page comprising product information of the item, review information of the item, and a product attribute recommendation of the item, the product attribute recommendation determined based on an analysis of the plurality of purchase information and the plurality of review information of the plurality of other purchasers for the item.

2. The method of claim 1,
wherein the plurality of review information is identified according to the frequency of selection of the other purchasers corresponding to the physical attribute of the user among the plurality of other purchasers.

3. The method of claim 1, wherein a first product attribute recommendation is displayed on a first area of the first page, and a second product attribute recommendation is displayed on a second area of the first page, wherein the second area is distinguished from the first area, wherein the second area is located in a portion to be exposed without scrolling when the first page is displayed on a user terminal.

4. The method of claim 1, further comprising:
receiving a second input; and
providing a second page including a first product attribute recommendation in response to the second input.

5. The method of claim 1, wherein the product attribute recommendation is selected based on a characteristic of the item.

6. The method of claim 1, wherein the first page further includes information indicating a first product attribute recommendation.

7. The method of claim 1, wherein the product information of the item includes an image of the item, and the first attribute is one of a size of the item or a color of the item.

8. The method of claim 2, further comprising:
identifying a size for the user based on the physical attribute of the other purchasers and a size of the item purchased by the other purchasers.

9. The method of claim 7, wherein:
when the first attribute is the size of the item, the product attribute recommendation includes a first recommendation indicating that the size of the item is smaller than the size shown in the image of the item, a second recommendation indicating that the size of the item is similar to the size shown in the image of the item, and a third recommendation indicating that the size of the item is larger than the size shown in the image of the item, and
when the first attribute is the color of the item, the product attribute recommendation includes a fourth recommendation indicating that the color of the item is similar to the color shown in the image of the item, a fifth recommendation indicating that the color of the item is the same as the color shown in the image of the item, and a sixth recommendation indicating that the color of the item is different from the color shown in the image of the item.

10. The method of claim 1, wherein the plurality of review information includes a most frequently presented answer among a plurality of answers for from the plurality of other purchasers based on the product attribute recommendation, and a frequency rate of the most frequently presented answer.

11. The method of claim 10, wherein the first page further includes a first indicator when the number of the most frequently presented answer among the answers is greater than a half of the number of the answers.

12. The method of claim 1, wherein the product attribute recommendation is represented on the first page to be always displayed on a terminal of the user even if the user scrolls beyond a specific range.

13. An electronic apparatus for providing item information, the electronic apparatus comprising:
a transceiver;
a processor, the processor being configured to:
receive, by the transceiver, a first input from a user device;
identify an item based on the first input;
determine a first attribute of the item;
determine a physical attribute of the user, the physical attribute of the user associated with the first attribute of the item;
identify, based on the physical attribute of the user, a plurality of other purchasers of the item who share the physical attribute;
determine a plurality of purchase information for the item associated with the plurality of other purchasers for the item, wherein the plurality of purchase information comprises information associated with the first attribute of the item;
identify a plurality of review information associated with the plurality of other purchasers for the item, wherein the plurality of review information comprises information associated with the first attribute of the item; and
generate a first page comprising product information of the item, review information of the item, and a product attribute recommendation of the item, the product attribute recommendation determined based on an analysis of the plurality of purchase information and the plurality of review information of the plurality of other purchasers for the item.

14. A non-transitory computer-readable storage medium stored thereon computer-readable instructions that, when executed by a processor of an electronic apparatus, cause the processor to:
receive a first input from a user device;
identify an item based on the first input;
determine a first attribute of the item;
determine a physical attribute of the user, the physical attribute of the user associated with the first attribute of the item;
identify, based on the physical attribute of the user, a plurality of other purchasers of the item who share the physical attribute;
determine a plurality of purchase information for the item associated with the plurality of other purchasers for the item, wherein the plurality of purchase information comprises information associated with the first attribute of the item;
identify a plurality of review information associated with the plurality of other purchasers for the item, wherein the plurality of review information comprises information associated with the first attribute of the item; and
generate a first page comprising product information of the item,review information of the item, and a product attribute recommendation of the item, the product attribute recommendation determined based on an analysis of the plurality of purchase information and the plurality of review information of the plurality of other purchasers for the item.
